(19) United States
(12) Patent Application Publication
(10) Pub. No.: US 2026/0160528 A1
(43) Pub. Date: Jun. 11, 2026

(54) FAUX FOLIAGE CAMOUFLAGE DEVICE

(71) Applicant: Joey Hasse, Marshall, MN (US)

(72) Inventor: Joey Hasse, Marshall, MN (US)

(21) Appl. No.: 18/969,459

(22) Filed: Dec. 5, 2024

(51) Int. Cl. F41H 3/00; A01M 31/02

(52) U.S. Cl. CPC F41H 3/00; A01M 31/025

(57) ABSTRACT

A faux foliage camouflage device for facilitating attachment of faux foliage to a supporting structure using a rubber coated formable wire includes a head and a plurality of branches coupled to and extending from the head. Each of the branches resembles foliage. A connector is coupled to and extends from the head. The connector is elongated and flexible such that the connector is formable into a shape to engage an extrinsic structure and engage the head to the extrinsic structure.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to foliage camouflage device and more particularly pertains to a new foliage camouflage device for facilitating attachment of faux foliage to a supporting structure using a rubber coated formable wire.

### (2) Description of Related Art Including Information Disclosed Under 37 CFR 1.97 and 1.98

The prior art relates to foliage camouflage devices. Known prior art lacks a formable connection tie to facilitate connection of faux foliage to a supporting structure.

### (h) BRIEF SUMMARY OF THE INVENTION

An embodiment of the disclosure meets the needs presented above by generally comprising a head and a plurality of branches coupled to and extending from the head. Each of the branches resembles foliage. A connector is coupled to and extends from the head. The connector is elongated and flexible such that the connector is formable into a shape to engage an extrinsic structure and engage the head to the extrinsic structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side view of a faux foliage camouflage device according to an embodiment of the disclosure.

FIG. 2 is a front view of an embodiment of the disclosure.

FIG. 3 is a cross-sectional view of an embodiment of the disclosure taken along line 3-3 of FIG. 2.

FIG. 4 is a front view of an embodiment of the disclosure.

FIG. 5 is a front view of an embodiment of the disclosure in use.

FIG. 6 is a front view of an embodiment of the disclosure in use.

### (j) DETAILED DESCRIPTION OF THE INVENTION

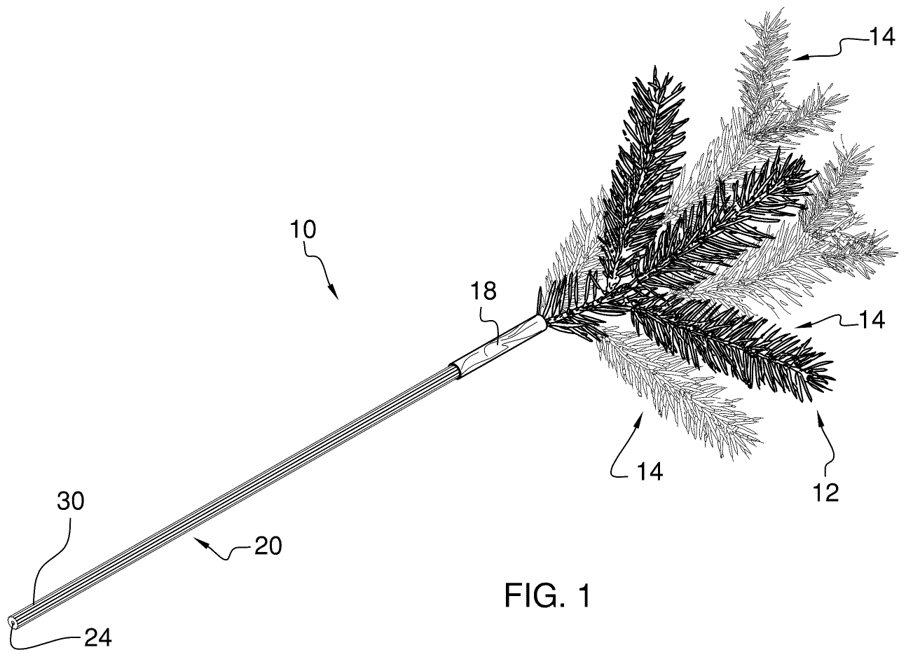

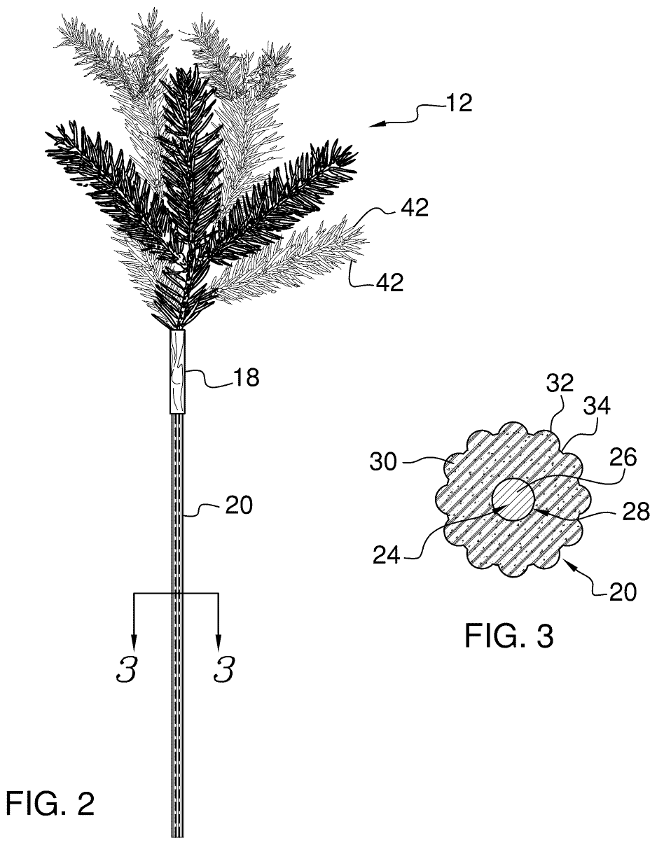

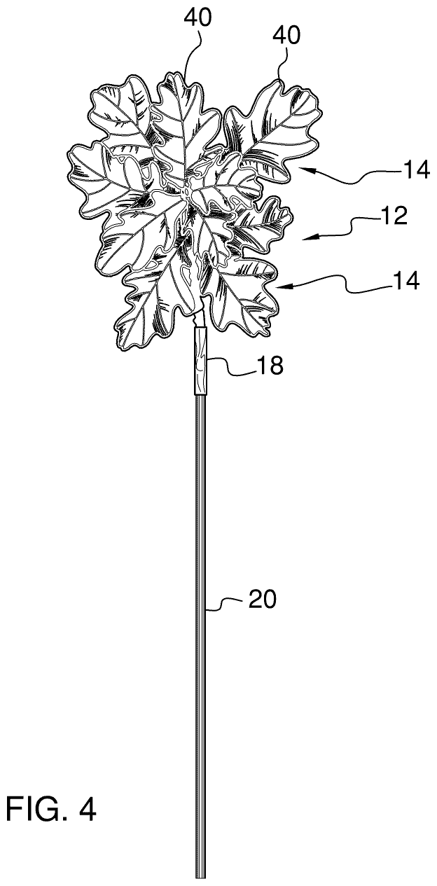

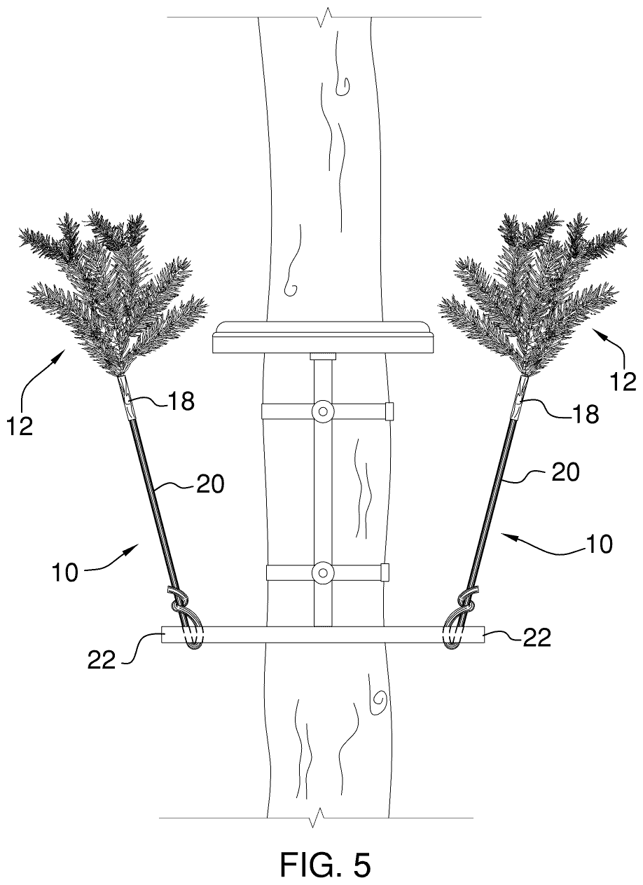

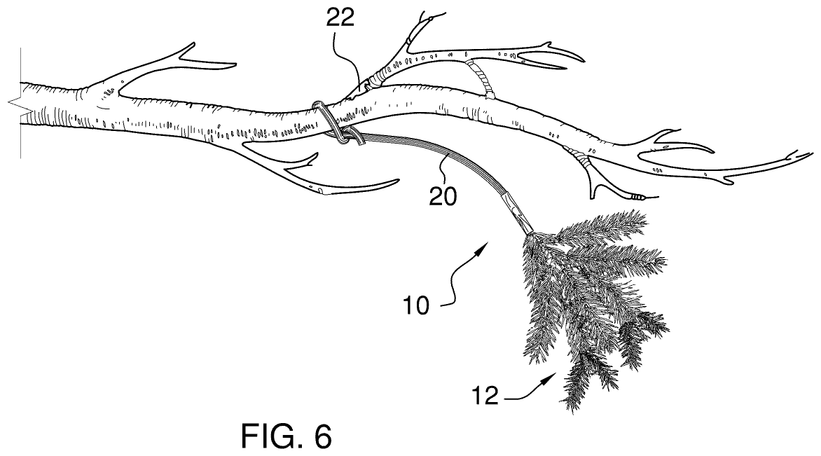

With reference now to the drawings, and in particular to FIGS. 1 through 6 thereof, a new foliage camouflage device embodying the principles and concepts of an embodiment of the disclosure and generally designated by the reference numeral 10 will be described.

As best illustrated in FIGS. 1 through 6, the faux foliage camouflage device 10 generally comprises a head 12 and a plurality of branches 14 coupled to and extending from the head 12. Each of the branches 14 is configured to resemble foliage. It is contemplated that foliage means any plant or part of a plant which may occur in nature, particularly in areas in which a person might hunt. A collar 18 is coupled to a connector 20 adjacent to the head 12. The collar 18 is rigid such that it may be grasped to facilitate carrying the device 10. The connector 20 is coupled to and extends from the head 12. Being coupled to the head 12 may occur directly or indirectly through the collar 18. The connector 20 is elongated and flexible such that connector 20 is formable into a shape configured to engage an extrinsic structure 22. Extrinsic within this context may be a hunting blind, elevated platform, tree branches, shrubs, or the ground including being shaped into a straight line suitable for insertion into the ground. Thus, the head 12 is engaged to the extrinsic structure 22 and the connector 20 is further positionable to place the head 12 into a desired position to enhance camouflage or a hunting position.

The connector 20 includes a core 24. The core 24 is constructed of a formable material 26. The core 24 has a circular shape 28 perpendicular to a central longitudinal axis of the core 24. The core 24 may comprise metal such as is used on conventional twist tie connectors. The connector further includes a cover 30. The cover 30 extends over the core 24. The cover 30 is flexible such that the cover 30 bends with forming of the core 24. The cover 30 has an outer surface 32 and a plurality of grooves 34 extending into the outer surface 32 of the cover 30. Each of the grooves 34 extends along a length of the cover 30/The grooves 34 are parallel to each other and arranged radially around the outer surface 32 of the cover 30. The cover 30 is resiliently compressible wherein the outer surface 32 of the cover 30 is configured for conforming to the extrinsic structure 22 when the connector 20 is positioned to frictionally engage or wrap around the extrinsic structure 22. The cover 30 comprises rubber of the type used in conventional twist tie connectors.

The branches 14 may have a plurality of leaves 40 wherein the head 12 is configured to resemble deciduous foliage. Alternatively, the branches 14 may have a plurality of needles 42 wherein the head 12 is configured to resemble evergreen foliage.

In use, the connector 20 is attached to the extrinsic structure 22 and the head 12 is positioned as desired to provide enhanced camouflage of the extrinsic structure 22 or the user when positioned by the extrinsic structure 22. It is contemplated that several of the device 10 may be used for camouflage of a larger area if desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A faux foliage camouflage device comprising:
a head;
a plurality of branches coupled to and extending from said head, each of said branches being configured to resemble foliage;
a connector coupled to and extending from said head, said connector being elongated and flexible such that connector formable into a shape configured to engage an extrinsic structure whereby said head is engaged to the extrinsic structure.

2. The faux foliage camouflage device of claim 1, wherein said connector further comprises:
a core, said core being constructed of a formable material; and
a cover, said cover extending over said core, said cover being flexible such that said cover bends with forming of said core.

3. The faux foliage camouflage device of claim 2, further comprising said core having a circular shape perpendicular to a central longitudinal axis of said core.

4. The faux foliage camouflage device of claim 2, further comprising said cover having an outer surface and a plurality of grooves extending into said outer surface of said cover, each of said grooves extending along a length of said cover,
5. The faux foliage camouflage device of claim 4, further comprising said grooves being parallel to each other and arranged radially around said outer surface of said cover.

6. The faux foliage camouflage device of claim 2, further comprising said cover being resiliently compressible wherein said outer surface of said cover is configured for conforming to the extrinsic structure.

7. The faux foliage camouflage device of claim 1, further comprising said branches having a plurality of leaves wherein said head is configured to resemble deciduous foliage.

8. The faux foliage camouflage device of claim 1, further comprising said branches having a plurality of needles wherein said head is configured to resemble evergreen foliage.

9. The faux foliage camouflage device of claim 1, further comprising a collar coupled to said connector adjacent to said head.

10. The faux foliage camouflage device of claim 9, further comprising said collar being rigid.

11. The faux foliage camouflage device of claim 2, wherein said cover comprises rubber.

12. The faux foliage camouflage device of claim 2, wherein said core comprises metal.

13. A faux foliage camouflage device comprising:
a head;
a plurality of branches coupled to and extending from said head, each of said branches being configured to resemble foliage;
a connector coupled to and extending from said head, said connector being elongated and flexible such that connector formable into a shape configured to engage an extrinsic structure whereby said head is engaged to the extrinsic structure, wherein said connector further comprises:
a core, said core being constructed of a formable material, said core having a circular shape perpendicular to a central longitudinal axis of said core, wherein said core comprises metal, and
a cover, said cover extending over said core, said cover being flexible such that said cover bends with forming of said core, said cover having an outer surface and a plurality of grooves extending into said outer surface of said cover, each of said grooves extending along a length of said cover, said grooves being parallel to each other and arranged radially around said outer surface of said cover, said cover being resiliently compressible wherein said outer surface of said cover is configured for conforming to the extrinsic structure, wherein said cover comprises rubber; and
a collar coupled to said connector adjacent to said head, said collar being rigid.

14. The faux foliage camouflage device of claim 13, further comprising said branches having a plurality of leaves wherein said head is configured to resemble deciduous foliage.

15. The faux foliage camouflage device of claim 13, further comprising said branches having a plurality of needles wherein said head is configured to resemble evergreen foliage.
